(19) United States
(12) Patent Application Publication
(10) Pub. No.: US 2014/0172643 A1
(43) Pub. Date: Jun. 19, 2014

(54) SYSTEM AND METHOD FOR CATEGORIZING AN IMAGE

(71) Applicants: Ehsan FAZL ERSI, Ottawa (CA); John Konstantine TSOTSOS, Richmond Hill (CA)

(72) Inventors: Ehsan FAZL ERSI, Ottawa (CA); John Konstantine TSOTSOS, Richmond Hill (CA)

(21) Appl. No.: 14/103,956

(22) Filed: Dec. 12, 2013

Related U.S. Application Data
(60) Provisional application No. 61/736,642, filed on Dec. 13, 2012.

(51) Int. Cl. G06K 9/62; G06Q 30/06; G06K 9/46

(52) U.S. Cl. CPC G06K 9/6267; G06K 9/4642; G06K 9/626; G06Q 30/0629
USPC 705/26.64; 382/170; 382/159; 382/224

(57) ABSTRACT

A system and method for performing object or context-based categorization of an image is described. A descriptor for image regions, which is represented by a histogram of oriented uniform patterns, is described. The descriptor is compared to descriptors of other images to determine a similarity score that accounts for distinctiveness, reducing perceptual aliasing. Additionally, a kernel alignment process considers only the descriptors that are determined to be most informative.

### TECHNICAL FIELD

The following is related generally to image categorization.

### BACKGROUND

A wide range of applications, from content-based image retrieval to robot localization, can benefit from scene recognition. Among such applications, scene and face retrieval and ranking are of particular interest, since they could be used to efficiently organize large sets of digital photographs. Managing large collections of photos is becoming increasingly important as consumers' image libraries are rapidly expanding with the proliferation of camera-equipped smartphones.

One issue in scene recognition is determining an appropriate image representation that is invariant to common changes in dynamic environments (e.g., lighting condition, view-point, partial occlusion, etc.) and robust against intra-class variations.

There have been several proposed solutions to the foregoing problems. One such proposal, inspired by the findings of cognitive and neuroscience research, attempts to classify scenes into a set of pre-specified categories according to the occurrence statistics of different objects observed in different scenes (e.g., a scene with many observed chairs likely belongs to the “Meeting room” category, but a scene with few observed chairs likely belongs to the “Office” category).

Further proposals estimate place categories (i.e., scene labels) from global configurations in observed scenes without explicitly detecting and recognizing objects. These proposals can be classified into two general categories: context-based and landmark-based. An example of a context-based proposal encodes spectral signals from non-overlapping sub-blocks to produce an image representation which can then be categorized. An example of a landmark-based proposal gives prominence to local image features in scene recognition. Local features characterize a limited area of the image but usually provide more robustness against common image variations (e.g., viewpoint). Generally, landmark-based methods perform more accurately than context-based methods in scene recognition but they suffer from high dimensionality, wherein images are commonly represented with vectors of very high dimensionality.

It is an object of the following to obviate or mitigate at least one of the foregoing issues.

### SUMMARY

In one aspect, a method of generating a descriptor for an image region is provided, the method comprising: (a) applying one or more oriented band-pass filters each generating a coefficient for a plurality of locations in the image region; (b) assigning one of a plurality of uniform pattern representations to each coefficient; and (c) generating, by a processor, for each band-pass filter a histogram representing the distribution of uniform patterns among the plurality of uniform pattern representations. (d) A system for generating a descriptor for an image region comprising a descriptor generation module operable to: (e) apply one or more oriented band-pass filters each generating a coefficient for a plurality of locations in the image region; (f) assign one of a plurality of uniform pattern representations to each coefficient; and (g) generate for each band-pass filter a histogram representing the distribution of uniform patterns among the plurality of uniform pattern representations.

In another aspect, a method for determining informative regions of an image to be used for classifying the image is provided, the method comprising: (a) obtaining a plurality of training images each associated with at least one classification; (b) generating a target kernel identifying the commonality of classifications of every pair of the training images; (c) dividing each of the training images into one or more corresponding regions; (d) generating for each region of each training image, at least one descriptor; (e) generating, by a processor, one or more similarity kernels each identifying the similarity of a region in every pair of the training images; and (f) determining one or more informative regions corresponding to the one or more regions whose combined similarity kernel is most closely aligned with the target kernel.

In a further aspect, a system for determining informative regions of an image to be used for classifying the image is provided, the system comprising: (a) obtaining a plurality of training images each associated with at least one classification; (b) generating a target kernel identifying the commonality of classifications of every pair of the training images; (c) dividing each of the training images into one or more corresponding regions; (d) generating for each region of each training image, at least one descriptor. (e) generating, by a processor, one or more similarity kernels each identifying the similarity of a region in every pair of the training images; and (f) determining one or more informative regions corresponding to the one or more regions whose combined similarity kernel is most closely aligned with the target kernel.

In yet another aspect, a method for enabling a user to manage a digital image library is provided, the method comprising: (a) generating one or more labels each corresponding to people or context classification; (b) displaying a plurality of images comprising the digital image library to a user; (c) enabling the user to: (i) select whether to classify the plurality of images by people or by context; and (ii) select one of the plurality of images as a selected image; (d) rearranging, by a processor, the plurality of images based on the similarity of the images to the selected images; (e) enabling the user to select a subset of the plurality of images to classify; and (f applying one of the one or more labels to the selected subset.

In yet a further aspect, a system for managing a digital image library is provided, the system comprising an image management application operable to: (a) generate one or more labels each corresponding to people or context classification; (b) display a plurality of images comprising the digital image library to a user; (c) enable the user to (i) select whether to classify the plurality of images by people or by context; and (ii) select one of the plurality of images as a selected image; (d) rearrange the plurality of images based on the similarity of the images to the selected images; (e) enable the user to select a subset of the plurality of images to classify; and (f) apply one of the one or more labels to the selected subset.

In an additional aspect, a system for managing digital images in an image database, one or more of the digital images being linked to electronic commerce information is provided, the system comprising an image generation module operable to: (a) generate a descriptor based on an image of a scene; (b) determine informative regions of the image to be used for classifying the image; (c) compare the image with all other images available within the image database; and (d) return from among the other images a set of similar images of the scene and their respective electronic commerce information, if any

In yet an additional aspect, a method for managing digital images in an image database, one or more of the digital images being linked to electronic commerce information is provided, the method comprising: (a) generating of a descriptor based on an image of a scene; (b) determining informative regions of the image to be used for classifying the image of the scene; (c) comparing, by an image generation module comprising one or more processors, the image with all other images available within the image database; (d) returning from among the other images a set of similar images of the scene and their respective electronic commerce information.

### DESCRIPTION OF THE DRAWINGS

The features of the invention will become more apparent in the following detailed description in which reference is made to the appended drawings wherein:

FIG. 1 is a block diagram of an image processing system;

FIG. 2 is a flowchart representation of an image processing process;

FIG. 3 is a flowchart representation of feature selection process;

FIG. 4 is a diagrammatic depiction of an example of generating a local binary pattern for a location in an image;

FIG. 5 is an illustrative example of generating a descriptor described herein;

FIG. 6 is an illustrative example of perceptual aliasing;

FIG. 7 is an illustrative example of similarity scores generated by the image processing system;

FIG. 8 is a depiction of a particular example weighting of image regions;

FIG. 9 is a flowchart corresponding to the use of one embodiment;

FIG. 10 is a screenshot of the embodiment;

FIG. 11 is another screenshot of the embodiment;

FIG. 12 is another screenshot of the embodiment; and

FIG. 13 is another screenshot of the embodiment.

### DETAILED DESCRIPTION

Embodiments will now be described with reference to the figures. It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It will also be appreciated that any module, unit, application, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Any application or module herein described may be implemented using computer readable/executable instructions that may be stored or otherwise held by such computer readable media.

In the following description, the term “scene” is used to indicate visual content and the term “image” is used to indicate a digital representation of a scene. For example, an image may be a digital file which represents a scene depicting a person standing on a mountain against the backdrop of the sky. The visual content may additionally comprise an object, collection of objects, human physical traits, and other physical manifestations that may not necessarily be considered objects per se (e.g., the sky).

In one aspect, a system and method for categorizing a scene depicted by an image is provided. Categorization of a scene may comprise object-based categorization, context-based categorization or both. In another aspect, a system and method for generating a descriptor for a scene is provided. The descriptor is operable to generate information about the context of a scene irrespective of the location within the scene of the contextual features. In other words, the context of a scene is invariant to the location of the contextual features. In yet another aspect, a system and method for assessing the similarity of descriptors is provided, wherein a similarity function comprises an assessment of distinctiveness. In a yet further aspect, a feature selection method based on kernel alignment is provided for determining implementation parameters (e.g., the regions in the image from which the visual descriptors are extracted, and the frequency level of oriented Gabor filters for which the visual descriptors are computed), which explicitly deals with multiple classes.

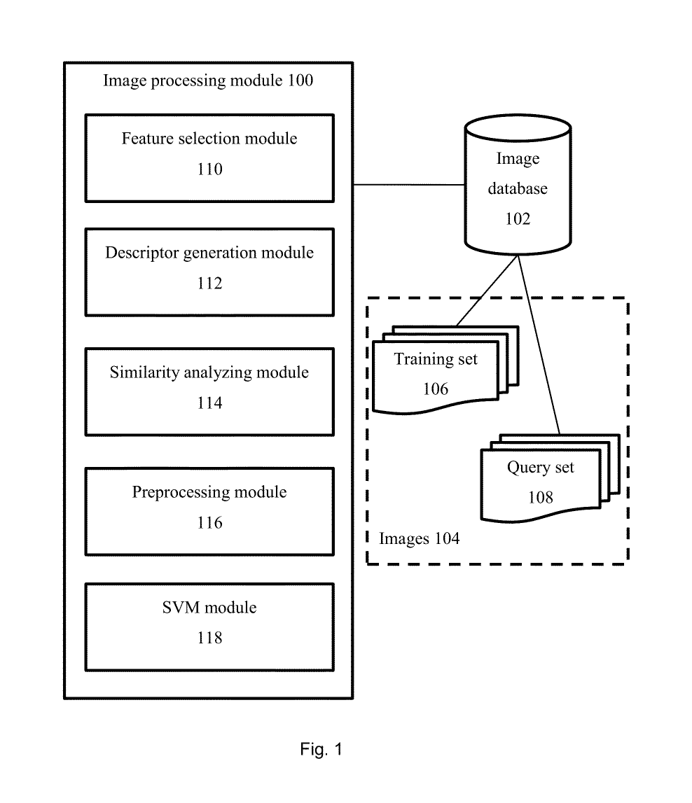

Referring now to FIG. 1, an image processing module 100 is communicatively linked to an image database 102. The image database 102 stores a plurality of images 104 comprising a training set 106. The images 104 may further comprise a query set 108. The query set 108 comprises query images depicting scenes for which categorization is desired, while the training set 106 comprises training images depicting scenes for which categorization is known.

The image processing module 100 comprises, or is linked to, a feature selection module 110, descriptor generation module 112 and similarity analyzing module 114. In additional implementations, the image processing module 100 may further comprise or be linked to a preprocessing module 116, a support vector machine (SVM) module 118 or both.

The image processing module 100 implements a training process and classification process. The training process comprises the identification of one or more regions of the training images that are most informative in terms of representing possible classifications of the images, and generates visual representations of the training images. In particular implementations, the training may further comprise the learning by the SVM module to perform classification. The classification process determines the classification of a query image based on an analysis of the informative regions of the image. Examples of classifications could be names of scenes or objects and descriptions of objects, scenes, places or events. Other examples would be apparent to a person of skill in the art.

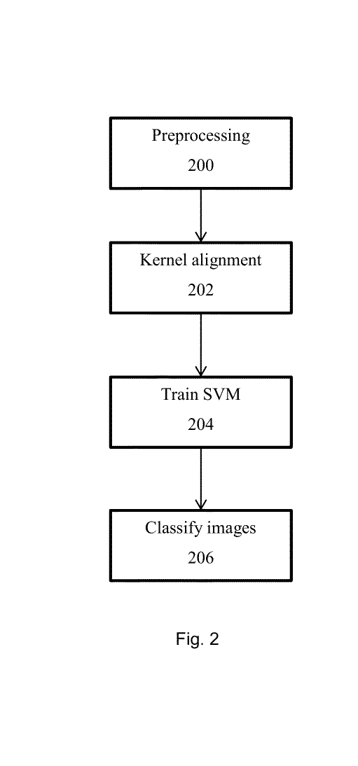

Referring now to FIG. 2, the training process may comprise, in some implementations as will be described herein, the preprocessing module 116 performing preprocessing on an image in block 200. For example, in certain examples, color images may be converted to greyscale or the contrast or illumination level of the image may be normalized. For example, it has been found that for context-based labeling, such as place or object descriptions, particular descriptors are preferably generated using color image information and for face image retrieval, descriptors are preferably generated using grayscale information.

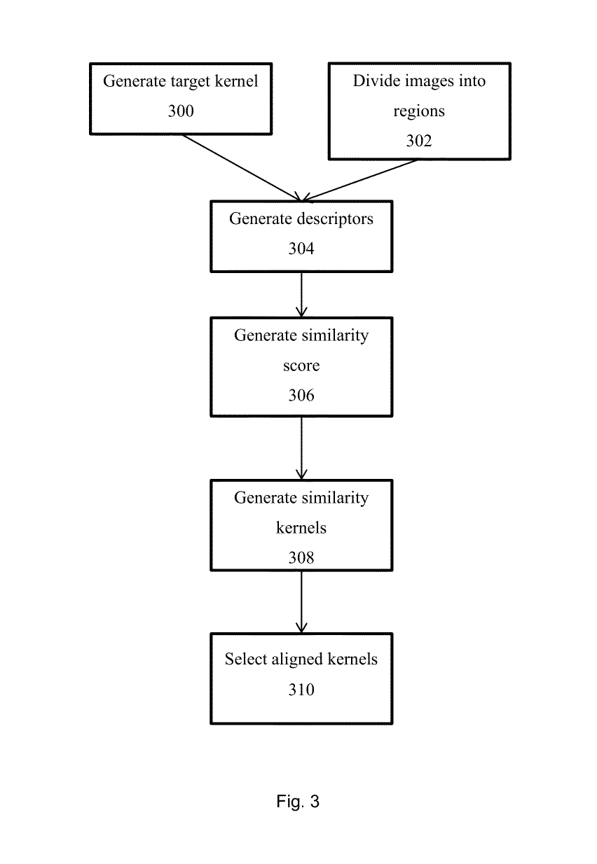

In block 202, the image processing module 110 directs the feature selection module 110 to perform feature selection, which is depicted in more detail in FIG. 3. The feature selection may, for example, be based on kernel alignment, which measures similarity between two kernel functions or between a kernel and a target function:

$$A ( {K}_{1} , {K}_{2} ) = \frac{{〈 {K}_{1} , {K}_{2} 〉}_{F}}{\sqrt{{〈 {K}_{1} , {K}_{1} 〉}_{F} {〈 {K}_{2} , {K}_{2} 〉}_{F}}} \qquad ( 3 )$$

where [symbol] K₁,K₂ [symbol] _{F} is the Frobenius dot product.

Feature selection enables the identification of one or more regions of the training images that are most informative (i.e., indicative of the image classification), and other parameters required to generate the visual descriptors, for subsequent purposes comprising the representations of the training and query images, and in particular implementations, the training of the SVM module.

Unlike prior techniques which use trial-and-error heuristics to determine arbitrary constants for implementation parameters (e.g., the size and spacing of the sub-blocks), feature selection module 110 applies feature selection so that only the descriptors extracted from the most informative image regions and frequencies contribute to the image representation.

From the training images, in block 300, the feature selection module generates a target kernel, which is a matrix identifying the correspondence of classification for each pair of training images. The target kernel may be embodied by a square matrix having a number of rows and columns each equal to the number of training images. For example, if 1000 training images are provided, the target kernel may be embodied by a 1000×1000 matrix. The kernel alignment process populates each target kernel element as “1” if the image identified by the row index is of the same classification as the image identified by the column index, and “0” otherwise. The target kernel will therefore comprise elements of either “0” or “1” wherein “1” denotes that the images corresponding to the element's row and column are of common classification and “0” denotes otherwise. In particular implementations, “−1” might be used instead of “0” to denote image pairs that correspond to different classification.

In block 302, the feature selection module may divide each of the training images into one or more regions. For example, each training image may be divided into 1 region (1×1), 4 regions (2×2), 9 regions (3×3), 16 regions (4×4), or 25 regions (5×5) and so on. Alternatively, each training image may be divided into a combination of overlapping divisions, for example 1 region, 4 regions which overlap the 1 region, 9 regions which overlap the 1 region (and perhaps the 4 overlapping regions as well), and so on. Alternatively, the set of extracted regions may be arbitrary, and may or may not cover the whole training image.

It will be appreciated that blocks 300 and 302 may be interchanged or may operate in parallel.

In block 304, the kernel alignment process directs the descriptor generation module 112 to generate at least one descriptor for each region of each training image. A plurality of descriptors may be generated for each region of the training images where, for example, descriptors are generated using frequency-dependent filters and each descriptor relates to a different filter frequency.

In one aspect, the descriptors are generated based upon a histogram of oriented uniform patterns, which have been found to provide a descriptor suitable for classifying scenes in images. The descriptor generation module 112, in this aspect, is designed based on the finding that categorization for an image may be provided by the application to the image, or regions thereof, of a band-pass filter applied at a plurality of orientations. Preferably, the filter is applied using at least four orientations. Preferably still, six to eight orientations are used.

In an example embodiment, the descriptor generation module 112 applies a plurality of oriented Gabor filters to each image and/or region. The output of each filter applied at a location x, in the region, provides a coefficient for that location. The coefficient for each such location may be given by:

$${v}_{k} ( x ) = \vert {\sum }_{{x}^{′}} i ( {x}^{′} ) {g}_{k} ( x - {x}^{′} ) \vert \qquad ( 1 )$$

where i(x) is the input image, gₖ(x) are oriented band-pass filters tuned to different/varying orientations (directions) at a certain spatial frequency (or substantially similar frequency), and vₖ(x) are the output amplitude of the filters at the location x.

The descriptor generation module 112 generates a histogram for the output of each oriented band-pass filter by assigning for each location in the region and at each orientation a numerical representation of local information. The numerical representation represents whether the location is one represented by a uniform pattern and, if so, which one. A uniform pattern is a Local Binary Pattern (LBP) with at most two bitwise transitions (or discontinuities) in the circular presentation of the pattern. When using a 3×3 neighborhood, for example, only 58 of the 256 total patterns are uniform. Thus, a histogram generated for representing the uniform patterns in an image or image region, in a 3×3 neighborhood implementation, may comprise 59 dimensions, one dimension for each uniform pattern and one dimension for all non-uniform patterns.

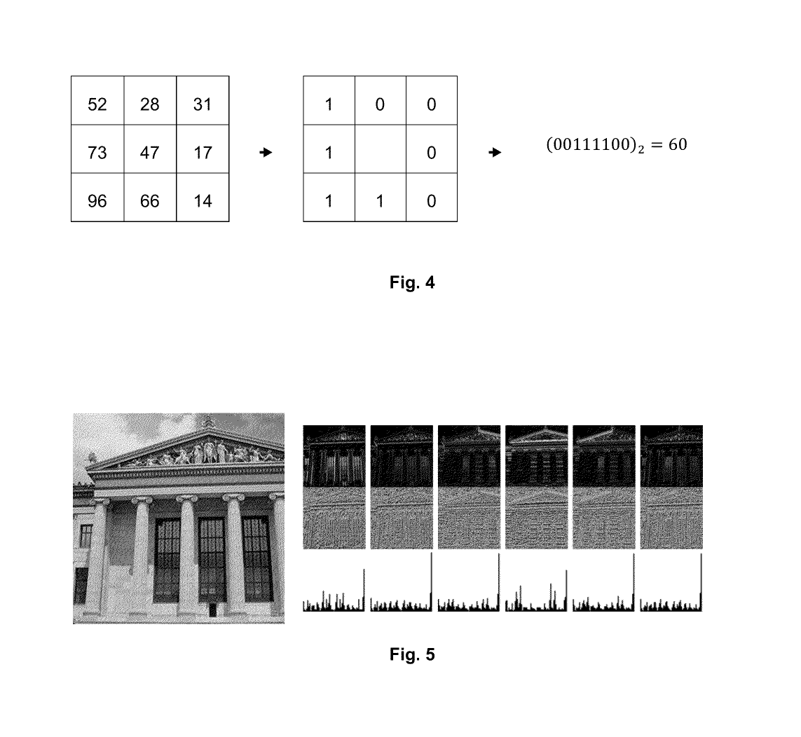

The histogram may be generated by first applying the LBP operator, which, in an example using a 3×3 neighborhood, labels each image pixel by subtracting the intensity at that pixel from the intensity at each of its eight neighboring pixels and converting the thresholded results (where the threshold is 0) to a base-10 number. An example of applying LBP to a location is shown in FIG. 4.

A texture descriptor is then generated for the image or region by aggregating the pixel labels into a histogram, where the dimensionality of the histogram is equivalent to the number of employed uniform local binary patterns plus one for the entire set of non-uniform patterns.

Computing the histograms of the uniform patterns from the output of each oriented band-pass filter and concatenating them together produces a global representation of the region, which is referred to herein as the Histogram of Oriented Uniform Patterns (HOUP). For example, the concatenated histogram, for a 3×3 neighborhood implementation, may be 59 multiplied by the number of oriented filters applied.

The number of oriented filters applied to a region can be selected based on several factors including, for example, available processing resources, degree of accuracy required, the complexity of the scenes to be categorized, the expected quality of the images, etc. In a particular embodiment, the Gabor coefficients may be determined at 6 orientations (e.g., from 0 to 5π/6 at an increment of 7π/6), which yields 6×59=354 dimensional representations. An example is shown in FIG. 5.

To obtain more compact representations, the dimensionality of HOUP descriptors may be reduced by projecting them on to the first M principal components, computed from the training set. In an example, M may be selected such that about 95% of the sum of all eigenvalues in the training set is accounted for by the eigenvalues of the chosen principal components. In an example, approximately 70 principal components may be sufficient to satisfy this condition for 354 dimensional representations.

Referring back to FIG. 3, for each pairing of training images, in block 306, the descriptors for each corresponding region are provided to the similarity analyzing module 114 to generate a similarity score. In an example, the descriptor for upper-left most region of each training image will be provided to the similarity analyzing module 114 to provide a similarity score. Each other region is likewise processed.

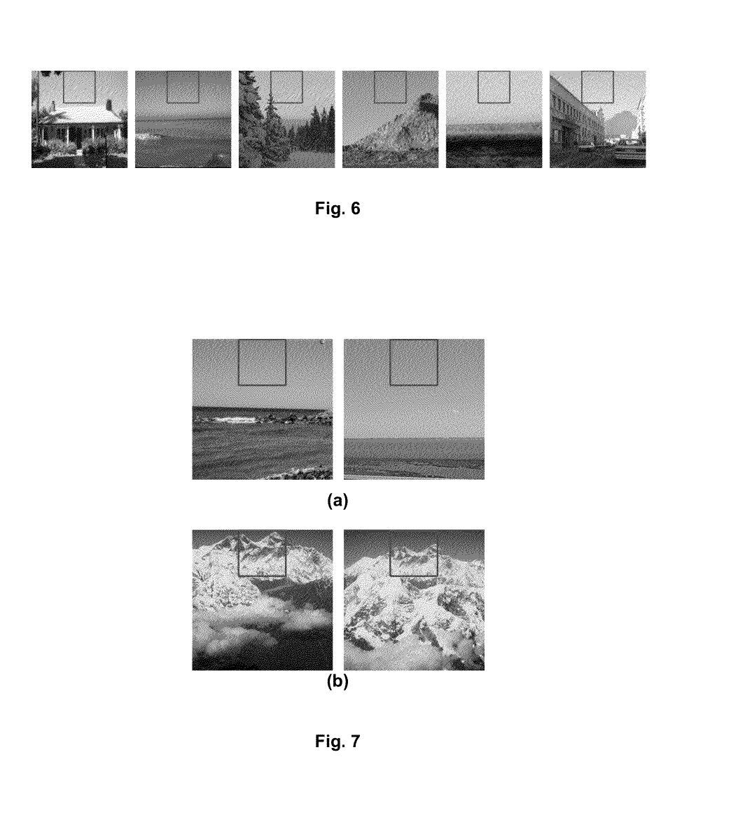

The similarity analyzing module 114 may compare the generated descriptors for each region using any of a wide variety of similarity measures, which may comprise known similarity measures. However, various known similarity measures are either general (i.e., not descriptor specific) or are learned to fit available training data. It has been found that a problem affecting some of the available similarity measures is that they may not explicitly deal with the perceptual aliasing problem, wherein visually similar objects may appear in the same location in images from different categories or places. An example of perceptual aliasing is illustrated in FIG. 6, where several images from different categories have visually similar “sky” regions at a certain region. Comparing each pair of these images using conventional measures, high similarity score is obtained between descriptors extracted from this region, while in fact the similarities are due to perceptual aliasing.

In one aspect, a similarity score may be determined by varying the known One-Shot Similarity (OSS) measure. In an example implementation, given a pair of HOUP descriptors, the Linear Discriminant Analysis (LDA) algorithm may be used to learn a model for each of the descriptors (as single positive samples) against a set of examples A. Each of the two learned models may be applied on the other descriptor to obtain a likelihood score. The two estimated scores may then be combined to compute the overall similarity score between the two descriptors:

$${s}_{n} ( {x}_{l}^{n} , {x}_{J}^{n} ) = {( {x}_{I}^{n} - {μ}_{A} )}^{T} {S}_{A}^{- 1} ( {x}_{J}^{n} - \frac{{x}_{I}^{n} + {μ}_{A}}{2} ) + {( {x}_{J}^{x} - {μ}_{A} )}^{T} {S}_{A}^{- 1} ( {x}_{I}^{n} - \frac{{x}_{J}^{n} + {μ}_{A}}{2} ) \qquad ( 2 )$$

where μ_{A} and S_{A} are mean and covariance of A, respectively.

Whereas the known OSS method prepares the example set A using a fixed set of background examples (i.e., samples from classes other than those to be recognized or classified), the similarity measure herein is obtained by replacing A with the complete training set.

Therefore, using the similarity measure described herein, if two descriptors are similar to each other but are indistinctive and relatively common in the dataset, they receive a low similarity score. On the other hand, when two descriptors are distinctive but have lower similarity than the examples of perceptual aliasing, they are still assigned high similarity score, since they can be separated better from the other examples in A.

FIG. 7 illustrates an example of similarity scores for two sets of images. In the first set shown in FIG. 7a, although an image region appears to be similar, it is non-distinctive and receives a low similarity score (in this example, sₙ=−0.2085). In the second set shown in FIG. 7b, the direct similarity of the image region is less although more distinctive and, therefore, receives a high similarity score (in this example, sₙ=+0.6313).

Given the similarity scores for the descriptors of particular corresponding region of each pair of images in the training set, in block 308, the feature selection module generates a similarity kernel for each such region. The similarity kernels are of the same dimension as the target kernel and similarly identify images paired according to the row and column indices. The number of similarity kernels generated is preferably equal to the number of candidate regions generated for each training image. For example, if each training image is divided into 25 regions, there are preferably 25 similarity kernels, each corresponding to one of the regions.

In a particular embodiment, for each candidate feature (image region or Gabor frequency) n, its corresponding descriptors extracted from the training images form a similarity kernel Kₙ, by using the similarity measure within a parameterized sigmoid function:

$${K}_{n} ( I , J ) = \frac{1}{1 + exp ( - {σ}_{n} {s}_{n} ( {x}_{I}^{n} , {x}_{J}^{n} ) )} \qquad ( 4 )$$

where sₙ(x_{I}ⁿ, x_{J}ⁿ) is the similarity between the nth descriptors extracted from images I and J, and σₙ is the kernel parameter, chosen to maximize A(Kₙ, K_{T}), using the unconstrained nonlinear optimization method.

In block 310, the feature selection module initially selects a similarity kernel that is most closely aligned to the target kernel. It may then proceed by performing an iterative greedy search for the next most informative features based on the alignment between the target kernel and each similarity kernel, formulated by:

$${Q}_{l} = arg {max}_{{K}_{i} ∈ {P}_{l}} {min}_{{K}_{j} ∈ {R}_{l}} ( A ( {K}_{i} \cdot {K}_{j} , {K}_{T} ) - A ( {K}_{j} , {K}_{T} ) ) \qquad ( 5 )$$

where Pₗ is the set of candidate features, Rₗ is the set of selected features up to iteration l, Qₗ is the feature to be selected in iteration l, and Kᵢ·Kⱼ is the joint kernel produced by combining sᵢ and sⱼ (see Equation 6). By taking min over all previously selected features, redundancy is avoided (when a candidate feature is similar to one of the selected features, this minimum will be small, preventing the feature from being selected). The max stage then finds the candidate feature with the largest additional contribution. The feature selection process may continue until no (or negligible) increment in alignment with target is gained by selecting a new feature, or for a predetermined number of iterations. For example, 50 such iterations may be used.

In block 310, the feature selection module can alternatively be based on evolutionary computation, where a large number of randomly generated sets of features are considered as initial candidate solutions (or initial population), and operations such as reproduction, mutation, recombination, and selection are used to repeatedly evolve the initial population (i.e., the set of candidate solutions) into a better and fitter population. The evolution process may continue until no (or negligible) increment in the average fitness of the candidate solutions in a population is gained by producing a new evolved population, or for a predetermined number of iterations. The fitness of a candidate solution is measured by computing the alignment of the constituent features with the target kernel. At the end of this evolutionary process, the candidate solution in the last population with the highest fitness score (i.e., the candidate solution whose constituent features produce a similarity kernel that is most aligned with the target kernel) may be chosen as the final solution.

Alignment to the target kernel indicates that the region's content is relevant to classification. The selected similarity kernels indicate which regions are most informative to determine the class of any particular query image. Preferably, the feature selection module assigns weights to the selected informative regions such that those that are relatively more informative are assigned higher weights.

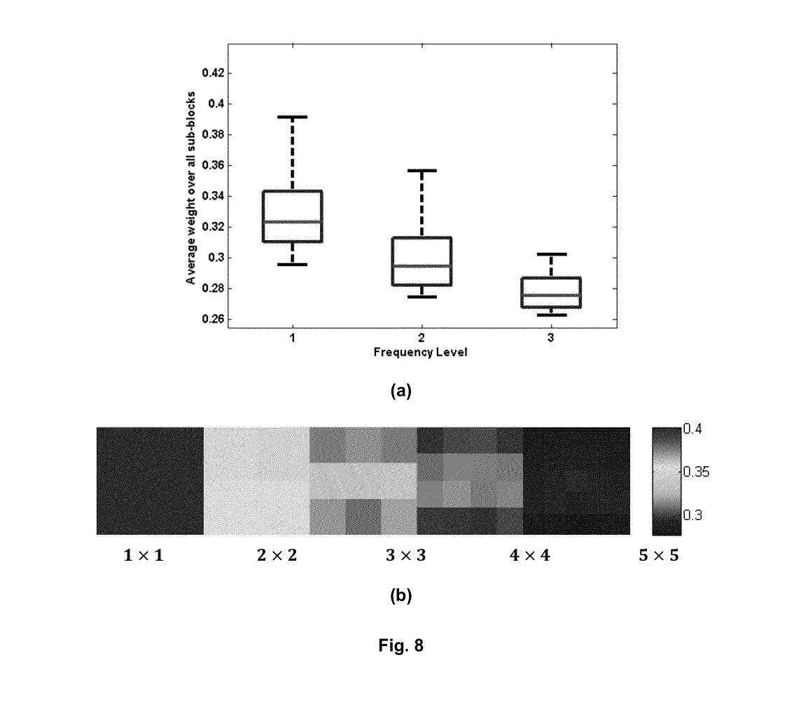

A particular example weighting of image regions is shown in FIG. 8, which relates to a particular set of images and a particular scene categorization problem. It is understood the weighting may change for different categorization problems. In this example, higher weights are assigned to the regions in 1×1 and 2×2 (since they capture larger image regions), while among the regions in the 3×3 grid, higher weights are assigned to those at the horizontal middle of the grid. Sub-blocks at the horizontal middle have relatively similar weights. This is consistent with the fact that while scene context can place constraints on elevation (a function of ground level), it may not provide enough constraints on the horizontal location of the salient and distinctive objects in the scene. Regions in 4×4 and 5×5 grids have much lower weights, as it may be the case that these regions are far too specific compared to 2×2 and 3×3 regions, with individual HOUP descriptors yielding fewer matches. The average weights assigned to each frequency level (over all regions) are also compared. The descriptors extracted at higher frequency levels have lower discriminative power, in this example.

The feature selection module provides to the image processing module the identifiers, and optionally the weights, of one or more informative regions. It is the descriptors of these regions that will subsequently be used to represent the training images and categorize the query images.

Once the most informative features are selected, each training image is represented by a collection of HOUP descriptors extracted from the selected image regions and Gabor frequencies. In a particular embodiment, the similarity between each pair of images is then measured by the weighted sum of the individual similarities computed between their corresponding HOUP descriptors:

$$S ( I , J ) = \frac{1}{1 + exp ( - σ {\sum }_{n = 1}^{N} {w}_{n} {s}_{n} ( {x}_{I}^{n} , {x}_{J}^{n} ) )} \qquad ( 6 )$$

where N is the total number of selected features, σ is the kernel parameter and wₙ are the combination weights. σ and wₙ are individually chosen to maximize A(Kₙ, K_{T}), using an optimization process. One such process determines the max/min of a scalar function, starting at an initial estimate. In an example, the scalar function returns the alignment between a given kernel and the target kernel for an input parameter σₙ. The initial estimate for σₙ may be empirically set to a likely approximation, such as 2.0 for example. The σₙ that maximizes the alignment may be selected as the optimal kernel parameter, and the alignment value corresponding to the optimal σₙ may be used as the weight of the kernel, wₙ. σ may be similarly determined.

In a particular embodiment, the descriptors for the selected most informative regions of the training images and their corresponding classifications can be used in block 204 to train the SVM module. SVM may be applied for multi-classification using the one-versus-all rule: a classifier is trained to separate each class from the rest and a test image is assigned to the class whose classifier returns the highest response. In particular embodiments, where the task is not a categorization and no generalization is sought, Nearest-Neighborhood (1−NN) may be used to recognize the images

In block 206, the image processing module is operable to perform the classification process to classify a query image into one of the classes represented in the training set. For any particular query image, the descriptor generation module can be used to generate descriptors for the informative regions determined during the training. In a particular implementation, these descriptors are provided to the SVM module for classification. As with the training images, the preprocessing module 116 may perform preprocessing on the query images.

It will be appreciated that several extensions to the foregoing are possible. For example, where a set of images exhibit or are identified as being temporally continuous (or at least temporally related), the image processing module may comprise a bias to enable scene categorization to include a constraint that the computed labels should vary smoothly and only change at timesteps when the scene category changes.

Additionally, images that are likely to be global examples of perceptual aliasing, or those without sufficient contextual information, can be discarded or labeled as “Unknown”. These images can be identified by a low similarity score to all other images.

Furthermore, the performance of HOUP descriptors may increase when used within the known bag-of-features framework.

In particular implementations, the foregoing aspects may be applied to a plurality of images to determine one or more category labels comprising, for example, names of objects or scenes, and descriptions of objects, scenes or events, provided the labels have been applied to at least one other image having the respective category. In this case, typically the labels would be applied to the training set initially, while the image processing module 100 would label the images of the query set as they are processed. Alternatively, images may be grouped by similarity where the labels are not available in the training set.

In one embodiment, the HOUP descriptors can be extracted from a set of fiducial landmarks in face images to enable the comparison between the appearances of a pair of face images. In a particular embodiment, the set of fiducial points can be determined by using the known Active Shape Model (ASM) method. This embodiment can be used with interactive interfaces to, for example, search collection of face images to retrieve faces, whose identities might be similar to that of the query face(s).

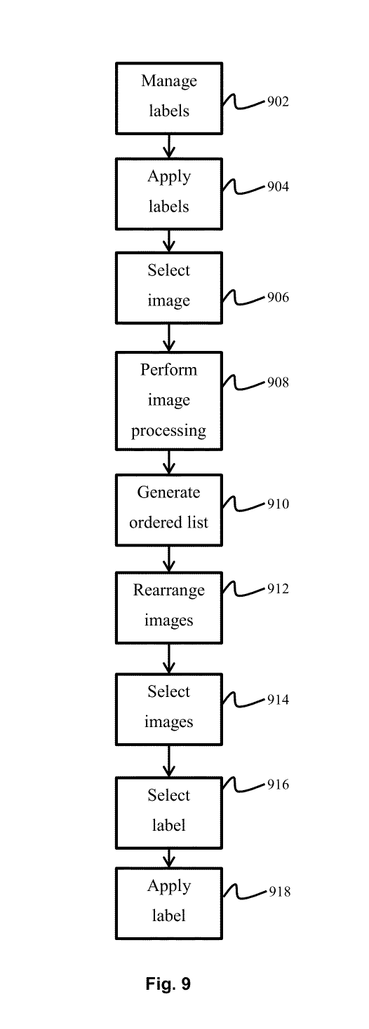

Referring now to FIG. 9, in one embodiment, the image processing module is accessible to a user for organizing an image library based on context and/or people. A typical implementation may comprise linking the image processing module to a desktop, tablet or mobile computing device. A user may access the image processing module using, for example, an image management application that is operable to display to the user a library of images managed by the user. These images may comprise images of various people, places and objects.

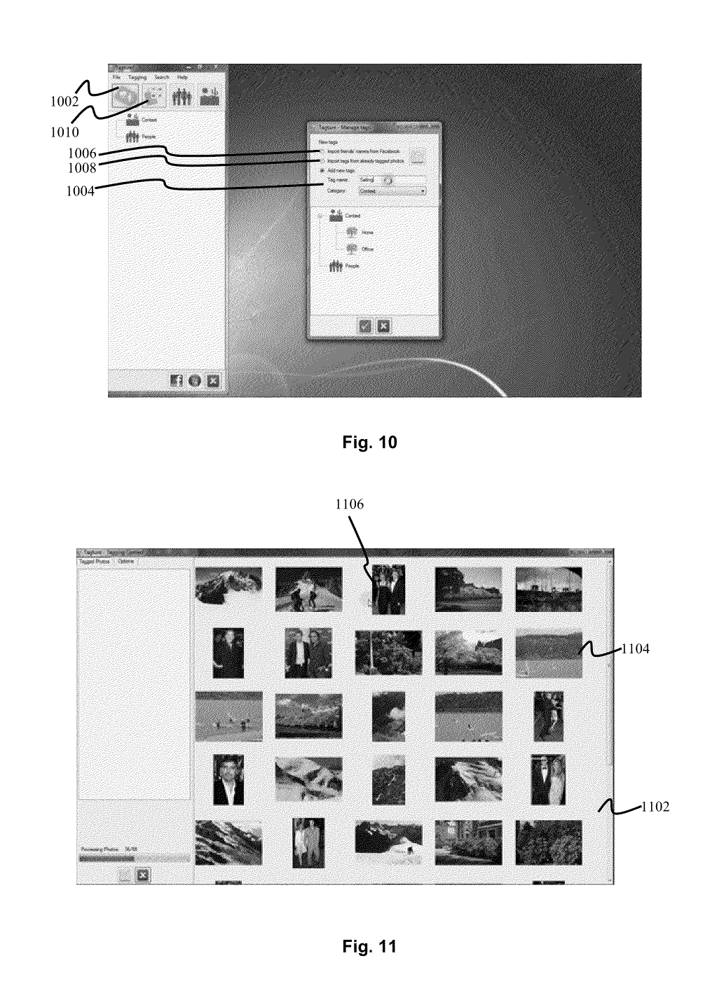

Referring to FIG. 10, a screenshot of an exemplary image management application is shown. In block 902, the image management application may provide the user with a selectable command (1002) to view, modify, add and delete labels, each corresponding to a people or context classification. A user may, for example, add an alphanumeric string label and designate the label as being related to context or people (1004). Optionally, the image management application is operable to import labels from third party sources. For example, labels may be generated from image tags on a social network (1006), or from previously labeled images (1008).

The image management application stores the labels and corresponding designation. The image management application may further provide the user with a selectable command (1010) directing the image management application to apply labels to either people or context.

Referring now to FIG. 11, once the user selects the command to apply labels, in block 904, the image management application may provide a display panel (1102) displaying to a user one or more images (1104) in a library. The example shown in FIG. 11 relates to the labeling of context, though a similar interface may be provided for labeling of people. The images (1104) may initially be displayed in any order, including, for example, by date taken, date added to library, file name, file type, metadata, image dimensions, or any other information, or randomly, as would be appreciated by a person of skill in the art.

Upon the user being presented with the images (1104), in block 906, the user may select one of the images as a selected image (1106). In block 908, the images (1104) are provided to the image processing module, which determines the similarity of each image to the selected image (1106) and returns the similarities to the image management application. In block 910, the image management application generates an ordered list of the images based upon similarity to the selected image (1106).

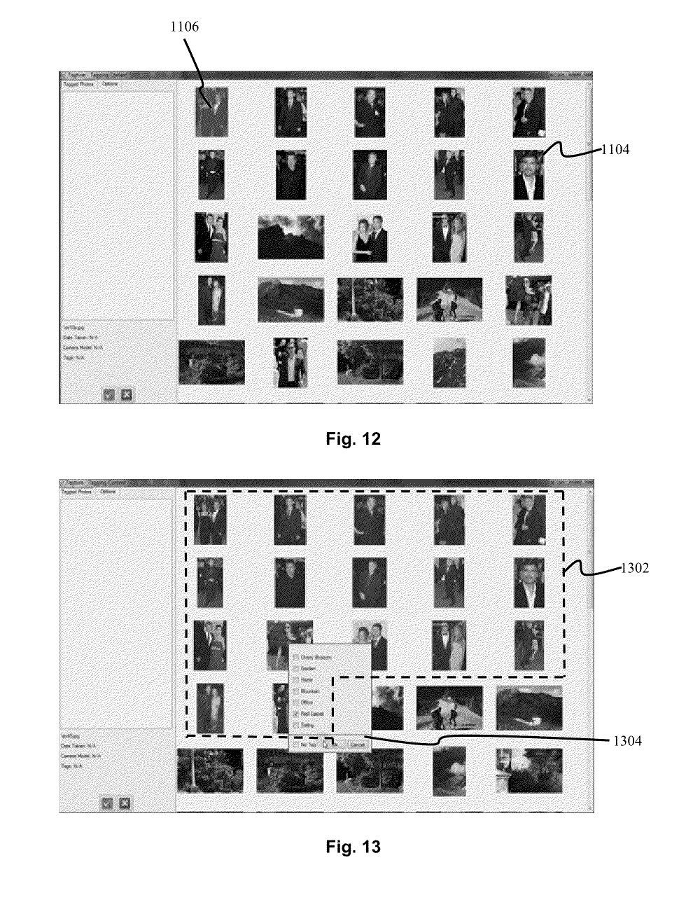

Referring now to FIG. 12, a ranking interface is shown. In block 912, the images (1104) may be rearranged in the display panel (1102) in accordance with the ordered list. It will be appreciated that, typically, a user will prefer the images arranged by highest similarity. As a result of the arrangement, the display panel (1102) is likely to show the images of a common context to the selected image (1106) in a block, or cluster; that is, the images sharing the selected image's context are likely to be displayed without interruption by an image not having that context.

Referring now to FIG. 13, in block 914, the user may thereafter select, in the display panel (1102), one or more of the images (likely a large number of images) which in fact share the context of the selected image. Selection of images may be facilitated by a boxed selection window, for example by creating a box surrounding the plurality of images to be selected using a mouse click-and-drag on a computer or a particular gesture on a tablet, as is known in the art, or by manually selecting each of the plurality of images, as is known in the art.

Once the desired images are selected (1302), in block 916, the user may access a labeling command (1304), using a technique known in the art such as mouse right-click on a computer or a particular gesture on a tablet, to display available labels. Where the user is labeling context, preferably only context labels are made available to the user, and likewise for labeling people where only people labels are preferably made available to the user. Optionally, the user may apply any of the previously created labels or may add a new label.

Preferably, the image management application enables the user to apply one label to selected images (1302) since it is unlikely the selected images (1302) will all share more than one context. However, each particular image may contain more than one context and may be grouped in other sets of selected images for applying additional context labels. Similar approaches may be taken for people labeling.

In block 918, the user may select a label to apply to the selected images. In block 920, the image management application may link the selected label to each selected image. In one example, the label is stored on the public segment of the image file metadata. In this manner, the label may be accessible to private or public third party devices, applications and platforms.

Substantially similar methods may be applied for people labeling in accordance with facial ranking as previously described.

It will be appreciated that the image management application as described above may enable substantial time savings for users by organizing large digital image libraries with labels for ease in search, access and management. A further extension of the image management application applies to content based image retrieval for enterprise level solutions wherein an organization needs to retrieve images in a short period of time from a large collection using a sample image.

In another embodiment, the foregoing may be applied to context-search in the field of rich media digital asset management. In this example, a keyword-based search may be performed to locate an image based on a previously performed classification. Images may be provided to the image processing module for classification. The images may thereafter be searched by classification keyword. In response to a keyword search, images having classifications matching the searched keyword are returned. Furthermore, the image processing module may display to a user performing the search other classifications which happen to be shown repeatedly in the same images as the classification being searched (for example, if “beach” is shown often in images of “ocean”).

In another example, a context-based search may be performed by classifying a sample image of the context and the image processing module returning images having the classification. Such search, in particular context-based search, is operable to discover desired images from among vast collections of images. In a specific example, a stock image database may searched for all images of a particular scene. For example, a news agency could request a search for all images that contain a family, a home and a real estate sign for a news report on “home real estate”. The image processing module may return one or more images from the stock image database that contain these objects.

Another example of context-based search provides real-time object recognition to classify objects for assistive purposes for disabled users. In this example, a user with vision limitations may capture an image of a particular location and the image processing module may provide the user with the classification of the location or the classification of the object itself. It will be appreciated that a device upon which the image processing module is operative may further be equipped with additional functionality to provide this information to the user, such as a text-to-voice feature to read aloud the classification.

In yet another example embodiment, an electronic commerce user may provide to the image processing module an image of a scene. The image processing module may be configured to return other similar images of the scene, which may further include or be linked to information relating to electronic commerce vendors that offer a product or service that leverages the visual content of the scene. For example, a retail consumer may provide to the image processing module an image of a product (for example, captured using a camera-equipped smartphone). The image processing module may be configured to return other images of the product, which may further include or be linked to information relating to merchants selling the product; the price of the product at each such merchant; and links to purchase the product online, if applicable.

Facial ranking may further be used in various applications, for example in “tagging” of users in images hosted on a social networking site, where a list of labels (users' names) might be presented to the user for each detected face, according to the similarity of the face to the users' profile face pictures. Face ranking can similarly be used with interactive user interfaces in the surveillance domain, where a library of surveillance images are searched to retrieve faces that might be similar to the query. In a specific example, a face image for a person may be captured by a user operating a camera-equipped smartphone and processed by the image processing module. A plurality of highly ranked matching faces can then be returned to the user to identify the person.

A further example in facial and context search is the detection and removal of identifiable features for purposes of visual anonymity in still or video images. These images may be processed by the image processing module, which can detect images with faces or other distinct objects. Additional algorithms can then be applied to isolate the particular faces or objects and mask them.

An additional example includes feature detection in biological or chemical imaging. For example, various image libraries may be provided to represent visual representations of particular biological or chemical structures. For example, a candidate image, representing a biological image, may be processed by the image processing module to categorize, classify and identify likely pathologies. An additional example includes feature detection in biological imaging. For example, various image libraries may be provided to represent visual representations of particular pathologies. A candidate image, representing a biological scene from a patient, may be processed by the image processing module to categorize, classify and identify similar biological scenes. In another example, a chemical image that contains measurement information of spectra and spatial, time information, may be processed by the image processing module to categorize, classify and identify chemical components.

It will be appreciated that any of the foregoing examples may be applied to video images in a similar manner as applied to still images.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

We claim:

1. A method of generating a descriptor for an image region comprising:
a) applying one or more oriented band-pass filters each generating a coefficient for a plurality of locations in the image region;
b) assigning one of a plurality of uniform pattern representations to each coefficient; and
c) generating, by a processor, for each band-pass filter a histogram representing the distribution of uniform patterns among the plurality of uniform pattern representations.

2. The method of claim 1, wherein the histograms corresponding to each band-pass filter are concatenated with one another.

3. The method of claim 2, wherein the descriptor has a dimension that is reducible by projecting it on to one or more principal components following the concatenation.

4. The method of claim 1, wherein the oriented band-pass filters are Gabor filters tuned to a substantially similar frequency but varying directions.

5. A system for generating a descriptor for an image region comprising a descriptor generation module operable to:
a) apply one or more oriented band-pass filters each generating a coefficient for a plurality of locations in the image region;
b) assign one of a plurality of uniform pattern representations to each coefficient; and
c) generate for each band-pass filter a histogram representing the distribution of uniform patterns among the plurality of uniform pattern representations.

6. The system of claim 5, wherein the descriptor generation module concatenates the histograms corresponding to each band-pass filter with one another.

7. The system of claim 6, wherein the descriptor has a dimension that is reducible by projecting it on to one or more principal components

8. A method for determining informative regions of an image to be used for classifying the image comprising:
a) obtaining a plurality of training images each associated with at least one classification;
b) generating a target kernel identifying the commonality of classifications of every pair of the training images;
c) dividing each of the training images into one or more corresponding regions;
d) generating for each region of each training image, at least one descriptor;
e) generating, by a processor, one or more similarity kernels each identifying the similarity of a region in every pair of the training images; and
f) determining one or more informative regions corresponding to the one or more regions whose combined similarity kernel is most closely aligned with the target kernel.

9. The method of claim 8, wherein the one or more informative regions are determined by an iterative search.

10. The method of claim 8, wherein the one or more informative regions are each assigned a weight.

11. The method of claim 8, wherein generating the at least one descriptor comprises:
a) applying one or more oriented band-pass filters each generating a coefficient for a plurality of locations in the region;
b) assigning one of a plurality of uniform pattern representations corresponding to each coefficient; and
c) generating for each band-pass filter a histogram representing the distribution of uniform patterns among the plurality of uniform pattern representations.

12. The method of claim 10, wherein the similarity kernels are generated by a similarity function that reduces perceptual aliasing.

13. The method of claim 10, wherein the similarity function that generates the similarity kernels comprises applying linear discriminant analysis.

14. The method of claim 8, further comprising training an image classification module to classify images using the informative regions.

15. The method of claim 14, wherein the image classification module is a support vector machine.

16. A system for determining informative regions of an image to be used for classifying the image comprising:
a) obtaining a plurality of training images each associated with at least one classification;
b) generating a target kernel identifying the commonality of classifications of every pair of the training images;
c) dividing each of the training images into one or more corresponding regions;
d) generating for each region of each training image, at least one descriptor.
e) generating, by a processor, one or more similarity kernels each identifying the similarity of a region in every pair of the training images; and
f) determining one or more informative regions corresponding to the one or more regions whose combined similarity kernel is most closely aligned with the target kernel.

17. The system of claim 16, wherein the one or more informative regions are determined by an iterative search.

18. A method for enabling a user to manage a digital image library comprising:
a) generating one or more labels each corresponding to people or context classification;
b) displaying a plurality of images comprising the digital image library to a user;
c) enabling the user to:
i. select whether to classify the plurality of images by people or by context; and
ii. select one of the plurality of images as a selected image;
d) rearranging, by a processor, the plurality of images based on the similarity of the images to the selected images;
e) enabling the user to select a subset of the plurality of images to classify; and
f) applying one of the one or more labels to the selected subset.

19. A system for managing a digital image library comprising an image management application operable to:
a) generate one or more labels each corresponding to people or context classification;
b) display a plurality of images comprising the digital image library to a user;
c) enable the user to
i. select whether to classify the plurality of images by people or by context; and
ii. select one of the plurality of images as a selected image;
d) rearrange the plurality of images based on the similarity of the images to the selected images;
e) enable the user to select a subset of the plurality of images to classify; and
f) apply one of the one or more labels to the selected subset.

20. A system for managing digital images in an image database, one or more of the digital images being linked to electronic commerce information, the system comprising an image generation module operable to:
a) generate a descriptor based on an image of a scene;
b) determine informative regions of the image to be used for classifying the image;
c) compare the image with all other images available within the image database;
d) return from among the other images a set of similar images of the scene and their respective electronic commerce information, if any

21. The system of claim 20, wherein the image database is available through a private computer network or a public computer network.

22. The system of claim 21, wherein the electronic commerce information relates to a product or a service, offered by an electronic commerce vendor, that leverages a visual content of the scene.

23. A method for managing digital images in an image database, one or more of the digital images being linked to electronic commerce information, the method comprising:
a) generating a descriptor based on an image of a scene;
b) determining informative regions of the image to be used for classifying the image of the scene;
c) comparing, by an image generation module comprising one or more processors, the image with all other images available within the image database;
d) returning from among the other images a set of similar images of the scene and their respective electronic commerce information.
